(19) United States
(12) Patent Application Publication
(10) Pub. No.: US 2024/0279036 A1
(43) Pub. Date: Aug. 22, 2024

(54) CRANE ASSEMBLIES FOR ATTACHMENT TO A VEHICLE TOW HITCH

(71) Applicants: Alan Taylor, Myakka City, FL (US); Brian Van Roy, Bradenton, FL (US); Jerry Jordan, Bradenton, FL (US); Beau Reid, Sarasota, FL (US)

(72) Inventors: Alan Taylor, Myakka City, FL (US); Brian Van Roy, Bradenton, FL (US); Jerry Jordan, Bradenton, FL (US); Beau Reid, Sarasota, FL (US)

(21) Appl. No.: 18/585,035

(22) Filed: Feb. 22, 2024

Related U.S. Application Data
(60) Provisional application No. 63/447,524, filed on Feb. 22, 2023.

(51) Int. Cl. B66C 23/38; B66C 23/00

(52) U.S. Cl. CPC B66C 23/38; B66C 23/54; B66C 2700/0364; B66C 2700/0378; B66C 2700/088

(57) ABSTRACT

Crane assemblies for attachment to a vehicle tow hitch are described.

### RELATED APPLICATIONS

This application claims the benefit of U.S. Application No. 63/447,524, entitled “CRANE ASSEMBLY FOR ATTACHMENT TO A VEHICLE TOW HITCH,” and filed on Feb. 22, 2024, which is incorporated herein by refence in its entirety.

### FIELD

Some implementations relate generally to vehicle mounted cranes, and, more particularly, to crane assemblies for attachment to a vehicle tow hitch.

### BACKGROUND

Some conventional vehicle mounted cranes may suffer from one or more limitations, For example, some conventional vehicle mounted cranes may take up space in a pickup truck bed, may require welding, and/or may require drilling holes through the pickup truck bed.

Embodiments were conceived in light of the above-mentioned problems and limitations, among other things. The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include a motorized crane assembly constructed to attach to a vehicle tow hitch. The crane assembly can include a keyed mounting arm including a key and interlocking flange constructed as a single weldment, an interlocking clevis coupled to the keyed mounting arm, and a base frame member coupled to the interlocking clevis so as to rotate from a stowed crane position to a deployed crane position via the interlocking clevis. The crane assembly can also include a mast coupled to the base frame member at a first end of the mast and one or more outriggers mounted to the mast so as to rotate from a stowed outrigger position to a deployed outrigger position and having a corresponding foot pad and an outrigger actuator to move the outrigger between the stowed outrigger position and the deployed outrigger position.

The crane assembly can further include a boom clevis mounted to a second end of the mast wherein the boom clevis is coupled to a boom rotation actuator configured to rotate the boom about the second end of the mast, a boom mounted to the boom clevis so as to rotate relative to the boom clevis, and a boom lift actuator coupled the boom and the boom clevis and configured to move the boom between a first boom angle and a second boom angle. The crane assembly can also include a boom extension constructed to fit within the boom and to slide along an axis of the boom in response to a boom extension actuator coupled to the boom and the boom extension and a hoist coupled to the boom having a rope wound on a cylinder, where the hoist is configured to release or retract the rope. The crane assembly can further include a hook coupled to an end of the rope and disposed at a distal end of the boom extension, an actuator control system, and an electrical control system.

In some implementations, the interlocking clevis includes one or more index notches and a spring-loaded slide switch mounted on the base frame member, wherein the spring-loaded slide switch includes a spring-loaded pop-up button for safety latching the interlocking clevis in a given position corresponding to a given one of the one or more notches into which the spring-loaded slide switch is locked into.

The crane assembly can also include one or more rails mounted on the mast. In some implementations, the outrigger actuator is a hydraulic actuator. The crane assembly can further include a mast pivot device configured to rotate the boom clevis about the second end of the mast.

In some implementations, the boom includes a first set of support rollers and a second set of support rollers, wherein the first set of support rollers support the boom extension on a first axis and the second set of support rollers support the boom extension on a second axis. In some implementations, the hoist is one of an electric hoist or hydraulic hoist. In some implementations, the rope includes one of a synthetic rope or a wire rope.

The crane assembly can also include a wired remote control or a wireless remote control. In some implementations, the actuator control system is a hydraulic control system having a hydraulic pump and one or more hydraulic valves. In some implementations, the electrical control system includes a plurality of outputs each corresponding to a direction of movement of an actuator.

Some implementations can include a manual crane assembly constructed to attach to a vehicle tow hitch. The crane assembly a keyed mounting arm including a key and interlocking flange constructed as a single weldment, a clevis coupled to the keyed mounting arm, and a base frame member coupled to the clevis so as to rotate from a stowed crane position to a deployed crane position via the clevis. The crane assembly can also include a mast coupled to the base frame member at a first end of the mast, one or more outriggers mounted to the mast so as to rotate from a stowed outrigger position to a deployed outrigger position and having a corresponding foot pad, and a boom clevis mounted to a second end of the mast configured to rotate the boom about the second end of the mast.

The crane assembly can further include a boom mounted to the boom clevis so as to rotate relative to the boom clevis, a hoist coupled to the boom having a rope wound on a cylinder, where the hoist is configured to release or retract the rope, and a hook coupled to an end of the rope and disposed at a distal end of the boom extension.

The crane assembly can also include one or more rails mounted on the mast. In some implementations, the hoist is one of an electric hoist or hydraulic hoist. In some implementations, the rope includes one of a synthetic rope or a wire rope. The crane assembly further includes a wired remote control or a wireless remote control configured to operate the hoist.

In some implementations, the one or more outriggers each have a locking rotational hinge configured to lock the outrigger into place. The crane assembly can also include one or more rails mounted on the boom.

### BRIEF DESCRIPTION OF THE DRAWINGS

FIG. 1 is a diagram showing a rear perspective view of an example motorized crane assembly 100 in accordance with some implementations.

FIG. 2 is a diagram showing a top view of an example motorized crane assembly in accordance with some implementations.

FIG. 3 is a diagram showing a front view of an example motorized crane assembly in accordance with some implementations.

FIG. 4 is a diagram showing a side view of an example motorized crane assembly in accordance with some implementations.

FIG. 5 is a diagram showing a rear view of an example deployed motorized crane assembly in accordance with some implementations.

FIG. 6 is a diagram showing a front view of an example deployed motorized crane assembly in accordance with some implementations.

FIG. 7 is a diagram showing a top view of an example deployed motorized crane assembly in accordance with some implementations.

FIG. 8 is a diagram showing a side view of an example deployed motorized crane assembly in accordance with some implementations.

FIG. 9 is a diagram showing a front view of an example deployed motorized crane assembly in accordance with some implementations.

FIG. 10 is a diagram showing a detailed view of an example deployed motorized crane outrigger in accordance with some implementations.

FIG. 11 is a diagram showing a perspective view of an example motorized crane assembly mounted to a vehicle tow hitch in accordance with some implementations.

FIG. 12 is a diagram showing a perspective view of an example motorized crane assembly mounted to a vehicle tow hitch in accordance with some implementations.

FIG. 13 is a diagram showing a top perspective view of an example motorized crane assembly mounted to a vehicle tow hitch in accordance with some implementations.

FIG. 14 is a diagram showing a perspective view of an example motorized crane assembly mounted to a vehicle tow hitch in accordance with some implementations.

FIG. 15 is a diagram showing a perspective view of an example motorized crane assembly mounted to a vehicle tow hitch in accordance with some implementations.

FIG. 16 is a diagram showing a detailed view of an example motorized crane assembly vehicle hitch mount in accordance with some implementations.

FIG. 17 is a diagram showing a perspective view of an example deployed motorized crane assembly mounted to a vehicle tow hitch in accordance with some implementations.

FIG. 18 is a diagram showing a perspective view of an example deployed motorized crane assembly vehicle tow hitch mount in accordance with some implementations.

FIG. 19 is a diagram showing a perspective view of an example deployed motorized crane assembly mounted to a vehicle tow hitch in accordance with some implementations.

FIG. 20 is a diagram showing a perspective view of an example deployed motorized crane assembly mounted to a vehicle tow hitch in accordance with some implementations.

FIG. 21 is a diagram showing a perspective view of an example deployed motorized crane assembly mounted to a vehicle tow hitch in accordance with some implementations.

FIG. 22 is a diagram showing a perspective view of an example deployed motorized crane assembly mounted to a vehicle tow hitch in accordance with some implementations.

FIG. 23 is a diagram showing a top perspective view of an example deployed motorized crane assembly mounted to a vehicle tow hitch in accordance with some implementations.

FIG. 24 is a diagram showing a detailed view of an example crane boom in accordance with some implementations.

FIG. 25 is a diagram showing a detailed view of an example crane boom in accordance with some implementations.

FIG. 26 is a diagram showing a detailed view of an example crane outrigger/stabilizer in a stowed position in accordance with some implementations.

FIG. 27 is a diagram showing a detailed view of an example crane outrigger/stabilizer in a deployed position in accordance with some implementations.

FIG. 28 is a diagram showing a detailed view of an example vehicle tow hitch mount in a stowed position in accordance with some implementations.

FIG. 29 is a diagram showing a detailed view of an example vehicle tow hitch mount in a deployed position in accordance with some implementations.

FIG. 30 is a diagram showing a detailed view of an example crane control housing and mast in accordance with some implementations.

FIG. 31 is a diagram showing a detailed view of an example crane hydraulic system schematic in accordance with some implementations.

FIG. 32 is a diagram showing a detailed view of an example crane electrical system schematic in accordance with some implementations.

FIG. 33 is a diagram showing a detailed view of example crane features in accordance with some implementations.

FIG. 34 is a diagram showing a front view of an example manual crane assembly in accordance with some implementations.

FIG. 35 is a diagram showing a detailed view of an example manual crane assembly mast-boom connection in accordance with some implementations.

FIG. 36 is a diagram showing a detailed view of an example manual crane assembly vehicle tow hitch mount in accordance with some implementations.

FIG. 37 is a diagram showing a detailed top view of an example manual crane assembly vehicle tow hitch mount in accordance with some implementations.

FIG. 38 is a diagram showing a side view of an example manual crane assembly in accordance with some implementations.

FIG. 39 is a diagram showing a front view of an example deployed manual crane assembly in accordance with some implementations.

FIG. 40 is a diagram showing a side view of an example deployed manual crane assembly in accordance with some implementations.

FIG. 41 is a diagram showing a top view of an example deployed manual crane assembly in accordance with some implementations.

FIG. 42 is a diagram showing a top view of an example deployed manual crane assembly in accordance with some implementations.

FIG. 43 is a diagram showing a perspective view of an example deployed manual crane assembly in accordance with some implementations.

FIG. 44 is a diagram showing an example stowed manual crane assembly mounted on a vehicle in accordance with some implementations.

FIG. 45 is a diagram showing an example stowed manual crane assembly mounted on a vehicle in accordance with some implementations.

FIG. 46 is a diagram showing an example stowed manual crane assembly mounted on a vehicle in accordance with some implementations.

FIG. 47 is a diagram showing an example deployed manual crane assembly mounted on a vehicle in accordance with some implementations.

FIG. 48 is a diagram showing an example deployed manual crane assembly mounted on a vehicle in accordance with some implementations.

FIG. 49 is a diagram showing an example deployed manual crane assembly mounted on a vehicle in accordance with some implementations.

FIG. 50 is a diagram showing an example deployed manual crane assembly mounted on a vehicle in accordance with some implementations.

### DETAILED DESCRIPTION

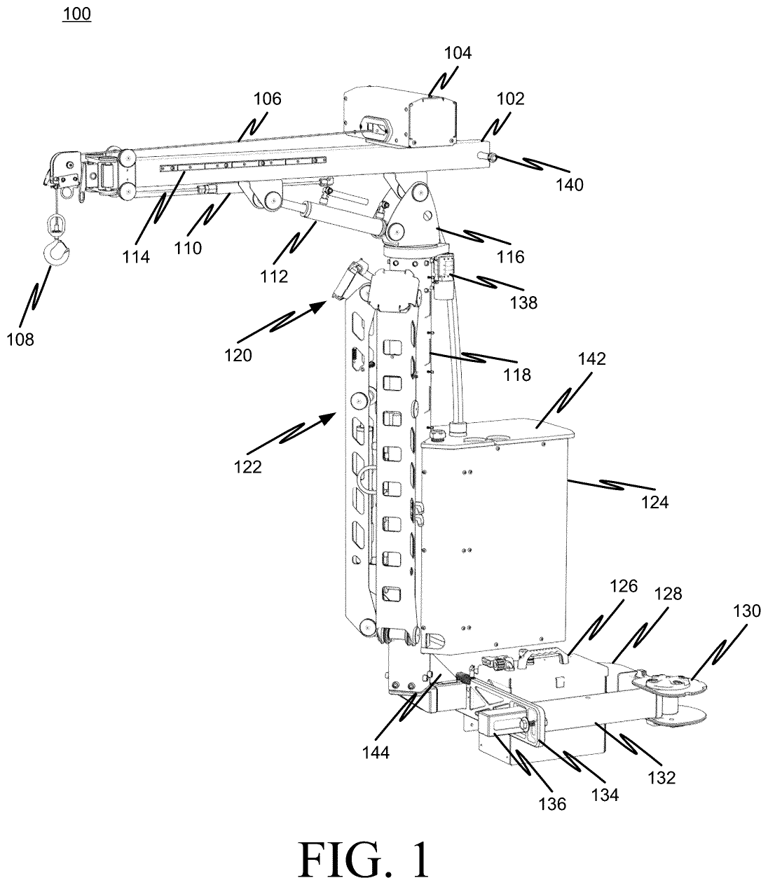

FIG. 1 is a diagram showing a rear perspective view of an example motorized crane assembly in accordance with some implementations. The crane assembly 100 includes a keyed mounting arm 132 including a key 136 (configurable for various types of vehicles and/or hitch receivers) and interlocking flange 134 (e.g., to secure the crane assembly when stowed) constructed as a single weldment, an interlocking clevis 130 coupled to the keyed mounting arm 132, and a base frame member 128 coupled to the interlocking clevis 130 so as to rotate from a stowed crane position to a deployed crane position via the interlocking clevis 130. The crane assembly 100 can mount to a vehicle hitch via the keyed mounting arm and a single bolt 1602 (and safety chain) in some implementations such that no drilling may be required in some instances.

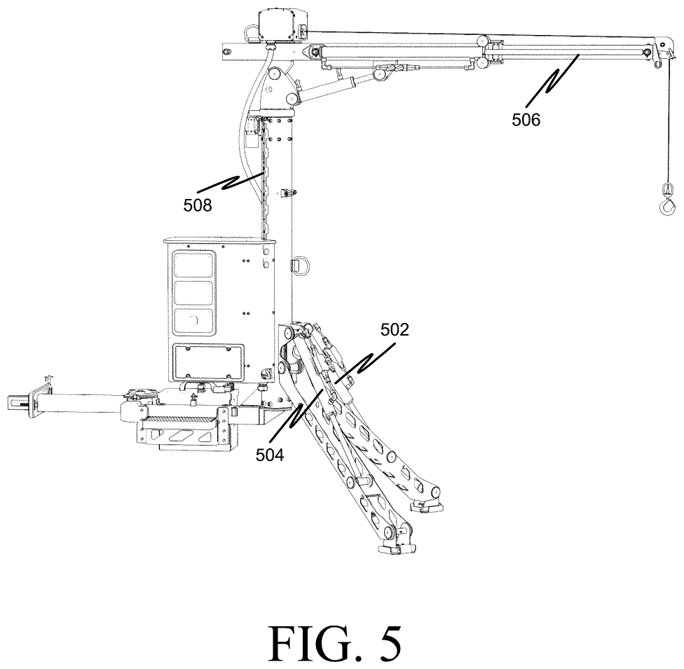

The crane assembly 100 also includes a mast 118 coupled to the base frame member 128 at a first end of the mast (and reinforced with one or more gussets 144) and one or more outriggers 122/123 mounted to the mast 118 so as to rotate from a stowed outrigger position to a deployed outrigger position and having a corresponding foot pad 120 (can be interchangeable depending on surface being deployed onto) and an outrigger actuator (see, FIG. 5) to move the outriggers 122/123 between the stowed outrigger position and the deployed outrigger position.

The crane assembly 100 includes a boom clevis 116 mounted to a second end of the mast 118 wherein the boom clevis 116 is coupled to a boom rotation member 138 (e.g., motorized with an actuator or manual) configured to rotate the boom 102 about the second end of the mast 118, a boom 102 mounted to the boom clevis 116 so as to rotate relative to the boom clevis 116, and a boom lift actuator 112 coupled the boom 102 and the boom clevis 116 and configured to move the boom 102 between a first boom angle and a second boom angle.

The crane assembly 100 includes a boom extension 506 constructed to fit within the boom 102 and to slide along an axis of the boom 102 in response to a boom extension actuator 110 coupled to the boom 102 and the boom extension 506 and a hoist 104 (e.g., electric or hydraulic) coupled to the boom 102 having a rope 106 (e.g., synthetic or wire rope) wound on a cylinder (not shown) within the hoist 104, where the hoist 104 is configured to release or retract the rope 106. The crane assembly 100 includes a hook 108 coupled to an end of the rope 106 and disposed at a distal end of the boom extension 506. The boom 102 can include posts 140 for mounting optional counterbalance weights. The posts 140 can also optionally be mounted on a telescoping rail to provide an offset for different loads. The crane assembly can also include a tabletop work area with optional cupholders made of a suitable material (e.g., King Starboard).

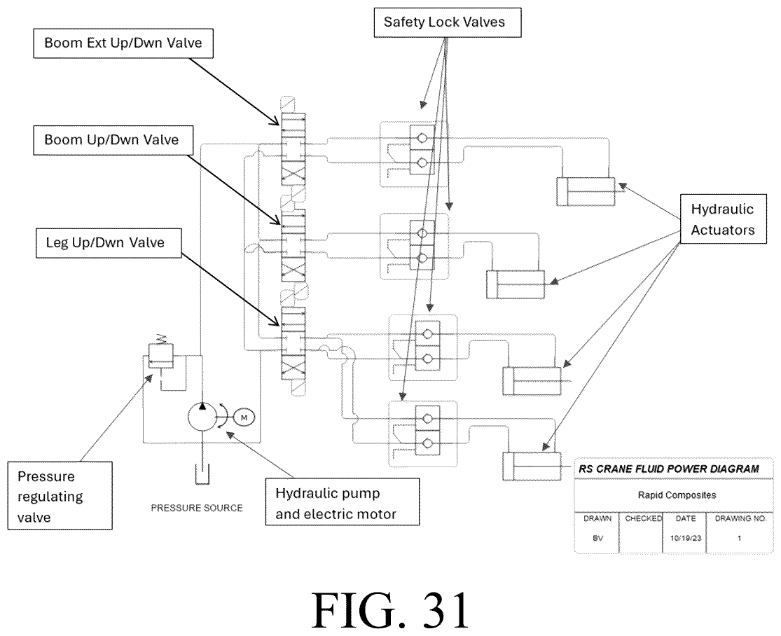

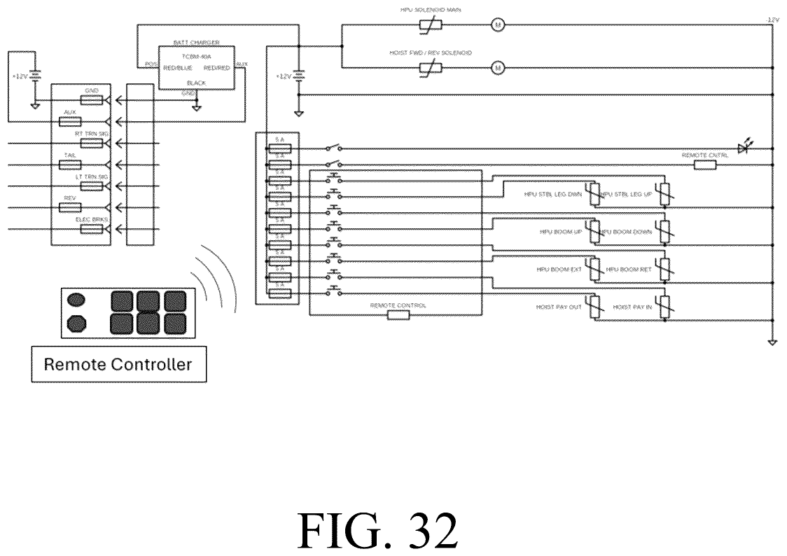

The crane assembly 100 includes an actuator control system (see, FIG. 31) and an electrical control system (see, FIG. 32) contained within housing 124. The crane assembly 100 also includes a battery and charge controller 126 configured to independently power the crane assembly and charge from vehicle power or shore power.

The crane assembly components can be formed from a suitable material for each component such as aluminum, steel, other metal, plastic, composite, etc. The actuators in the crane assembly can include any suitable actuator such as hydraulic, electric, gear driven, belt driven, worm gear driven, etc. The boom rotation actuator can include a mechanism such as a pinion and spur gear or an inline linear actuator and can be either electric or hydraulic. Any actuator can include an electric linear actuator, lead screw, or other suitable manual or mechanized device.

The outriggers/stabilizers can include hydraulic jack type devices, trailer jack type devices, scissor jack type devices, or any other suitable device for extending and bearing weight to stabilize the crane assembly.

### Click-Lock Connectors and Applications

Click-lock refers to connection systems described in U.S. Pat. No. 11,788,326, U.S. Application No. 63/448,240, and U.S. application Ser. No. ______ by the same inventors of 63/448,240, and which claims the benefit of U.S. Application No. 63/448,240, each of which is incorporated herein by reference in its entirety. Click-lock can be used at interfaces of components of the crane assembly. Click-lock connectors can be used on rails on boom and mast, e.g., click-lock can be used to interface to the rails, holes can be transverse to the rail and the click lock button can be used to slide accessories, tools, or implements along the rail. Jumbo versions of click can be used to attach sections of the crane together such as subassemblies (e.g., mast, boom, outriggers, etc.). In another example, the one that mounts on the hitch, the click lock mechanisms can be used to releasably attach the crane to the hitch. Because the crane assembly weight may be substantial (e.g., about 620 pounds), breaking the crane assembly down into subassemblies can make the crane more transportable.

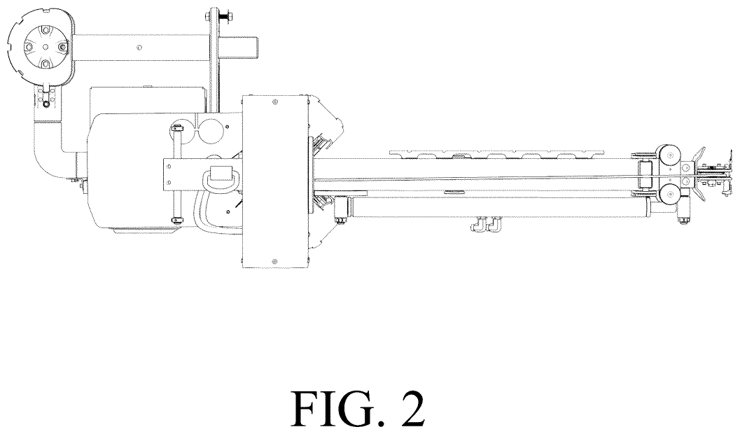

FIG. 2 is a diagram showing a top view of an example motorized crane assembly in accordance with some implementations.

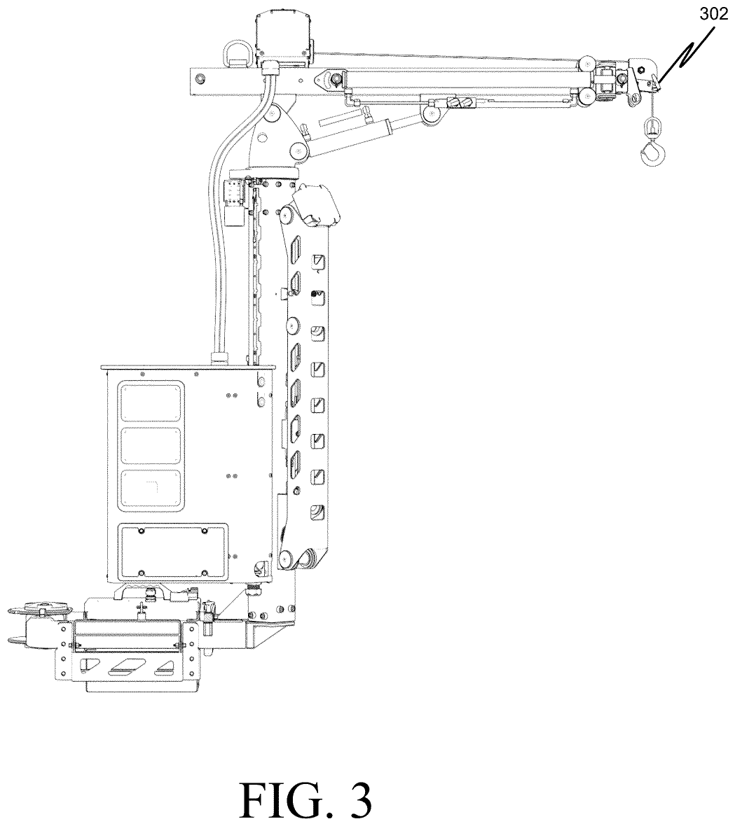

FIG. 3 is a diagram showing a front view of an example motorized crane assembly in accordance with some implementations. The boom extension 506 can include a winch or hoist shut off switch 302 to prevent the winch or hoist from over tensioning the rope 106.

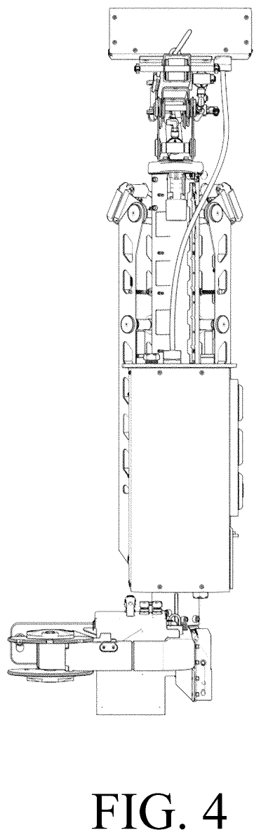

FIG. 4 is a diagram showing a side view of an example motorized crane assembly in accordance with some implementations.

FIG. 5 is a diagram showing a rear view of an example deployed motorized crane assembly in accordance with some implementations.

The crane assembly can also include one or more rails mounted on the mast.

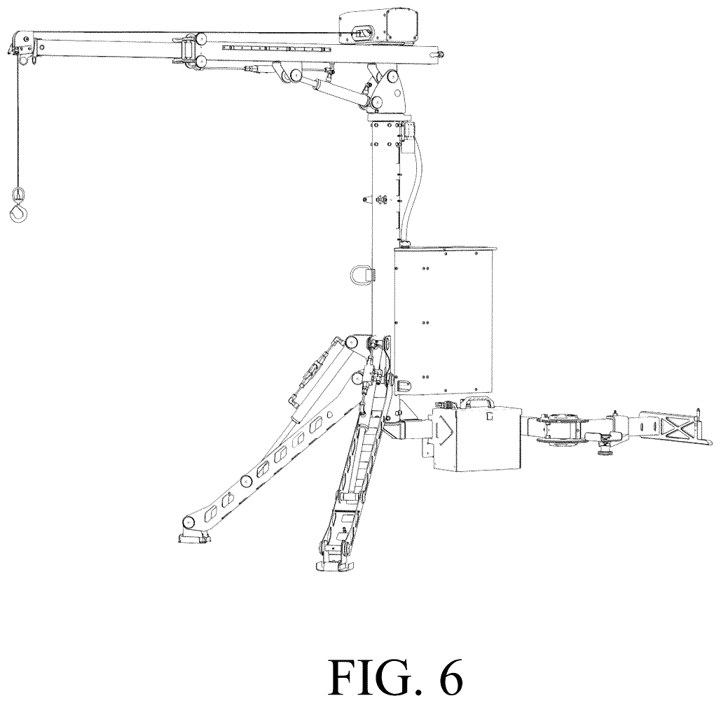

FIG. 6 is a diagram showing a front view of an example deployed motorized crane assembly in accordance with some implementations.

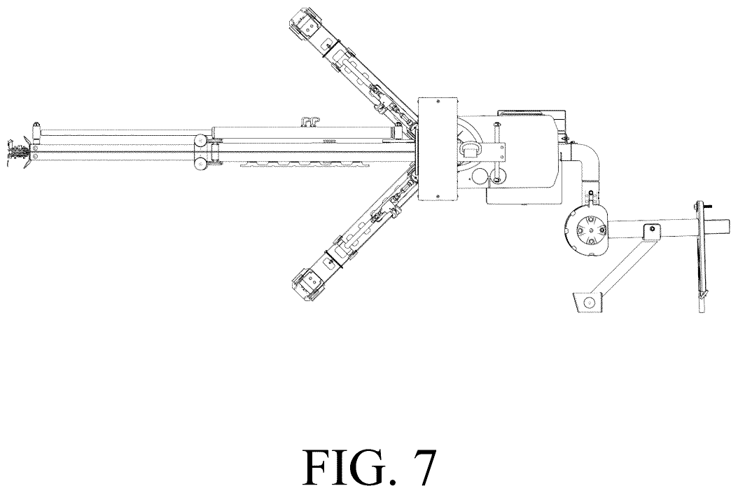

FIG. 7 is a diagram showing a top view of an example deployed motorized crane assembly in accordance with some implementations.

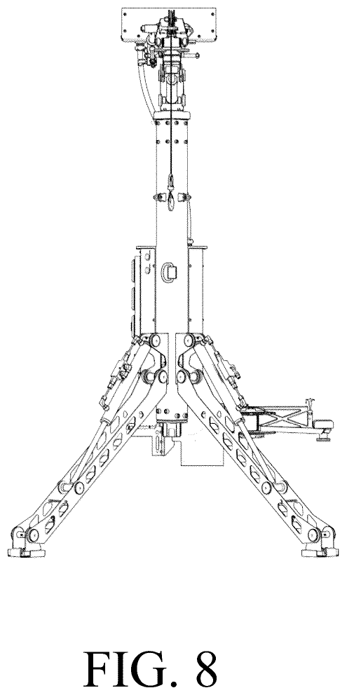

FIG. 8 is a diagram showing a side view of an example deployed motorized crane assembly in accordance with some implementations.

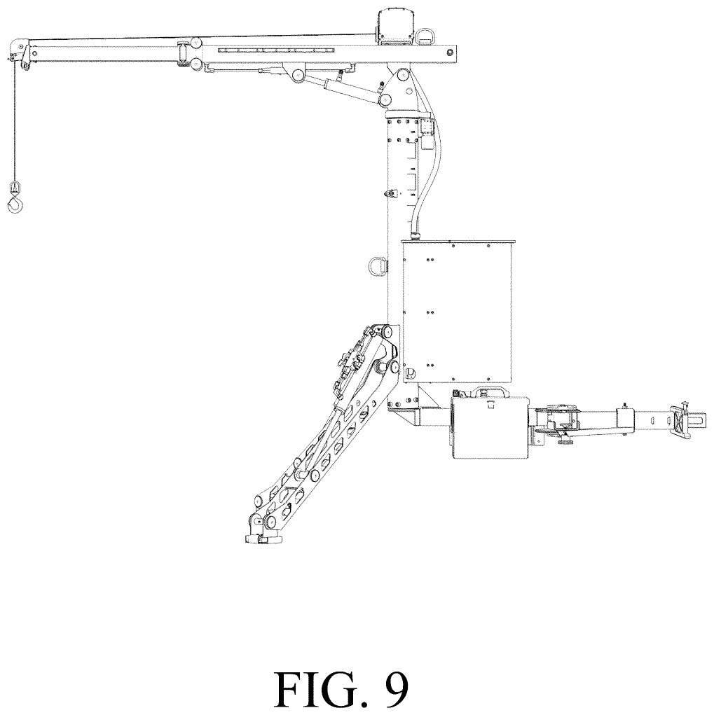

FIG. 9 is a diagram showing a front view of an example deployed motorized crane assembly in accordance with some implementations.

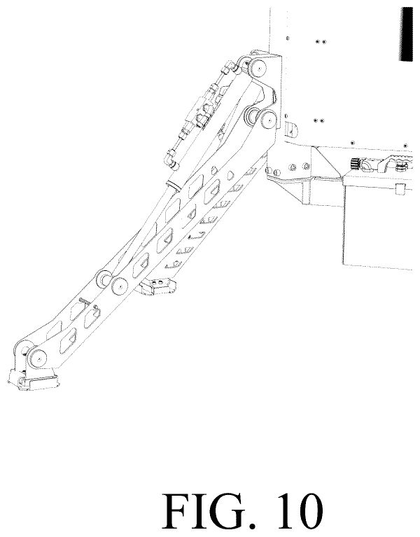

FIG. 10 is a diagram showing a detailed view of an example deployed motorized crane outrigger in accordance with some implementations.

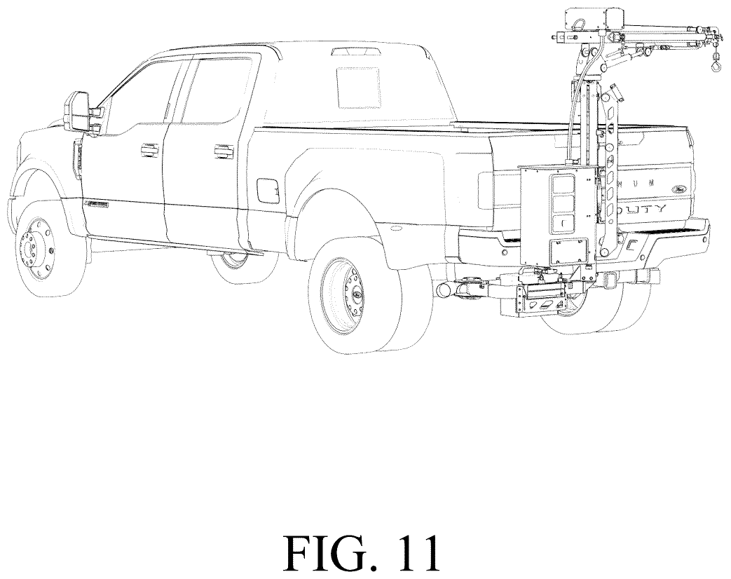

FIG. 11 is a diagram showing a perspective view of an example motorized crane assembly mounted to a vehicle tow hitch in accordance with some implementations.

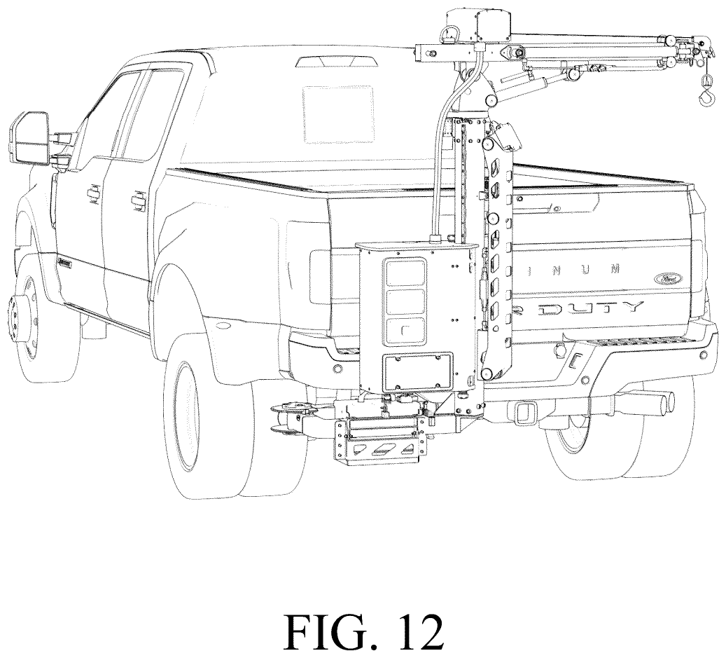

FIG. 12 is a diagram showing a perspective view of an example motorized crane assembly mounted to a vehicle tow hitch in accordance with some implementations.

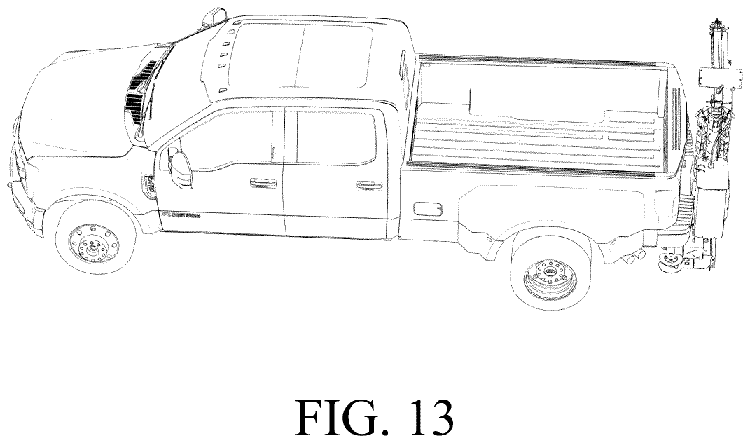

FIG. 13 is a diagram showing a top perspective view of an example motorized crane assembly mounted to a vehicle tow hitch in accordance with some implementations.

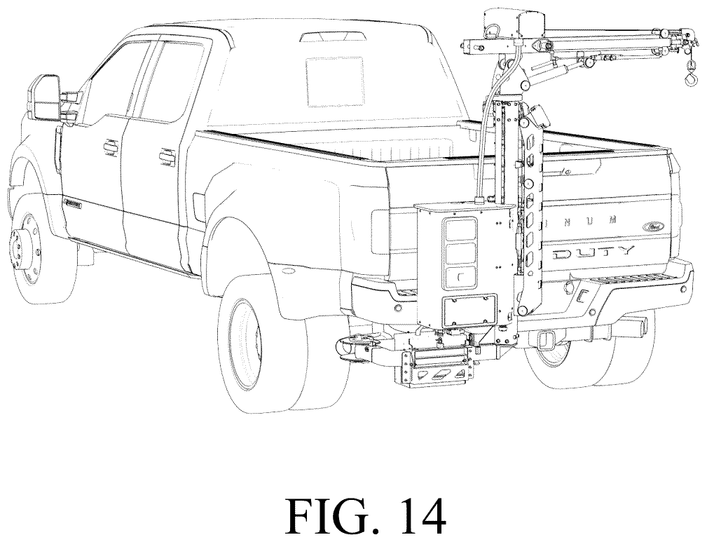

FIG. 14 is a diagram showing a perspective view of an example motorized crane assembly mounted to a vehicle tow hitch in accordance with some implementations.

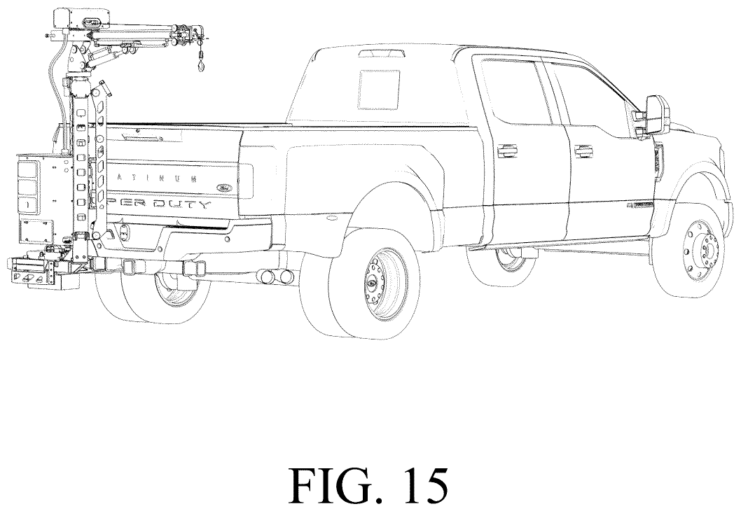

FIG. 15 is a diagram showing a perspective view of an example motorized crane assembly mounted to a vehicle tow hitch in accordance with some implementations.

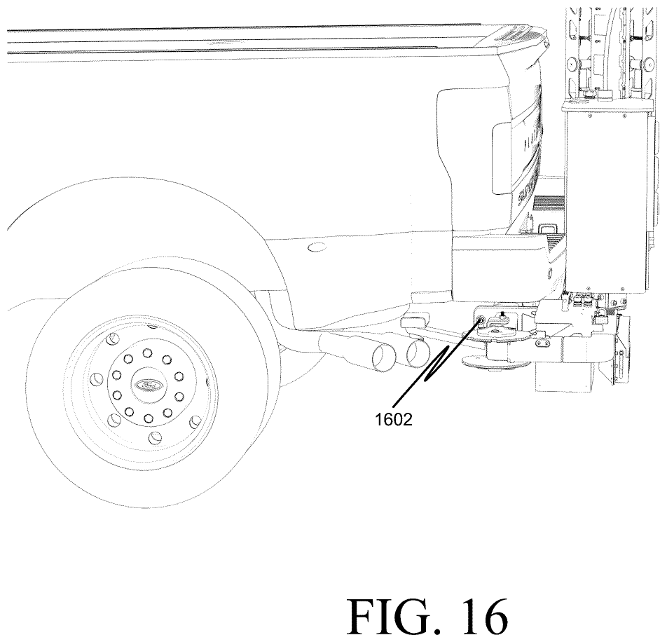

FIG. 16 is a diagram showing a detailed view of an example motorized crane assembly vehicle hitch mount in accordance with some implementations.

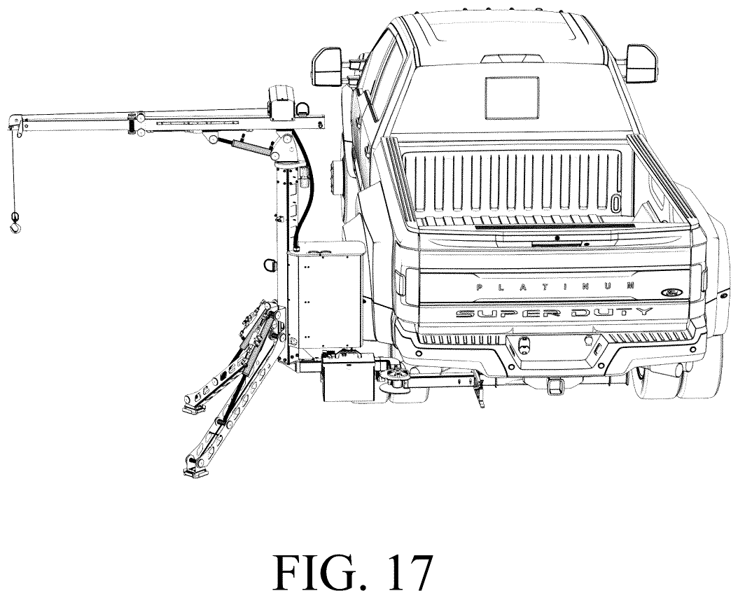

FIG. 17 is a diagram showing a perspective view of an example deployed motorized crane assembly mounted to a vehicle tow hitch in accordance with some implementations.

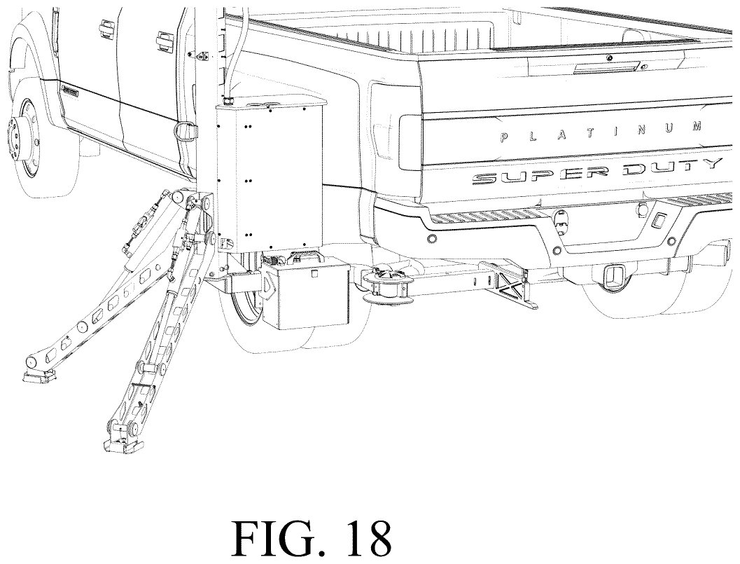

FIG. 18 is a diagram showing a perspective view of an example deployed motorized crane assembly vehicle tow hitch mount in accordance with some implementations.

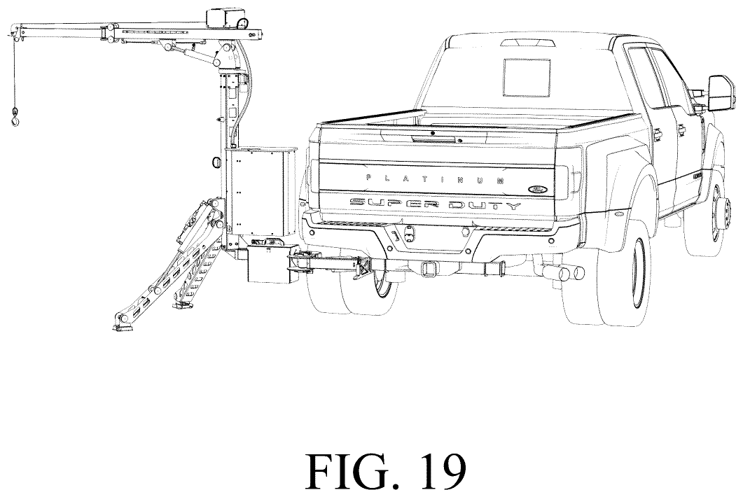

FIG. 19 is a diagram showing a perspective view of an example deployed motorized crane assembly mounted to a vehicle tow hitch in accordance with some implementations.

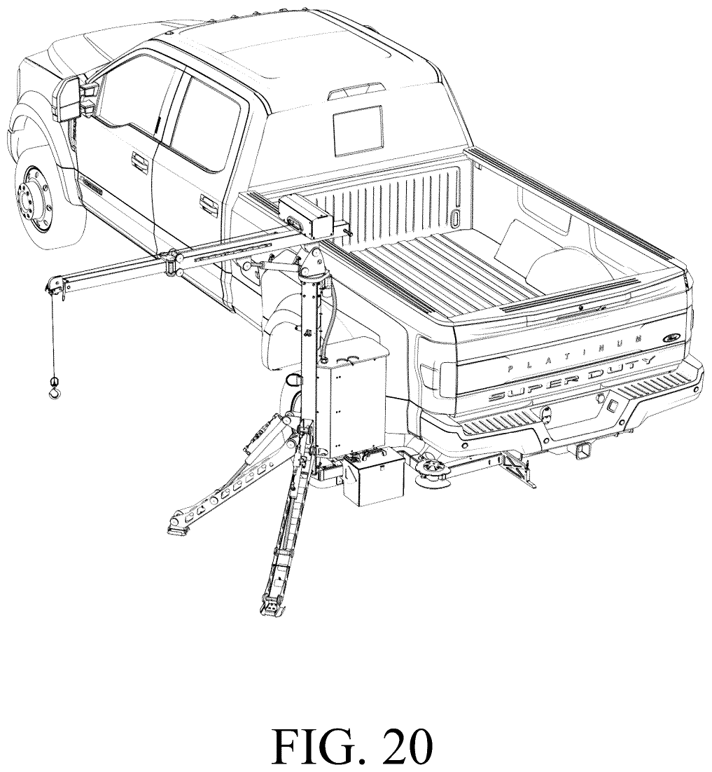

FIG. 20 is a diagram showing a perspective view of an example deployed motorized crane assembly mounted to a vehicle tow hitch in accordance with some implementations.

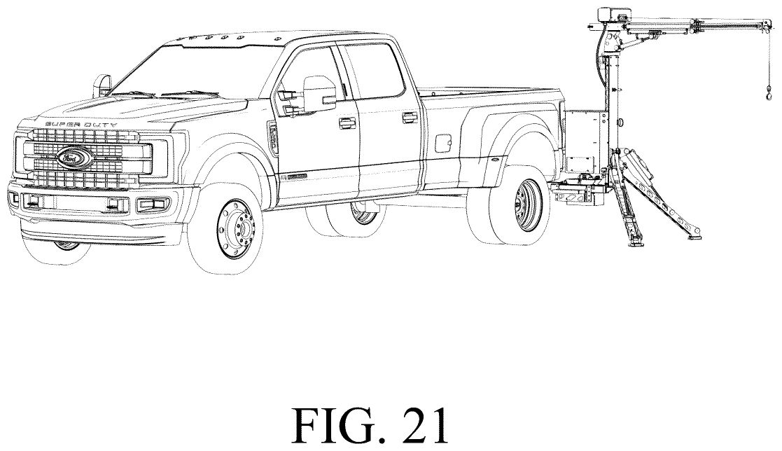

FIG. 21 is a diagram showing a perspective view of an example deployed motorized crane assembly mounted to a vehicle tow hitch in accordance with some implementations.

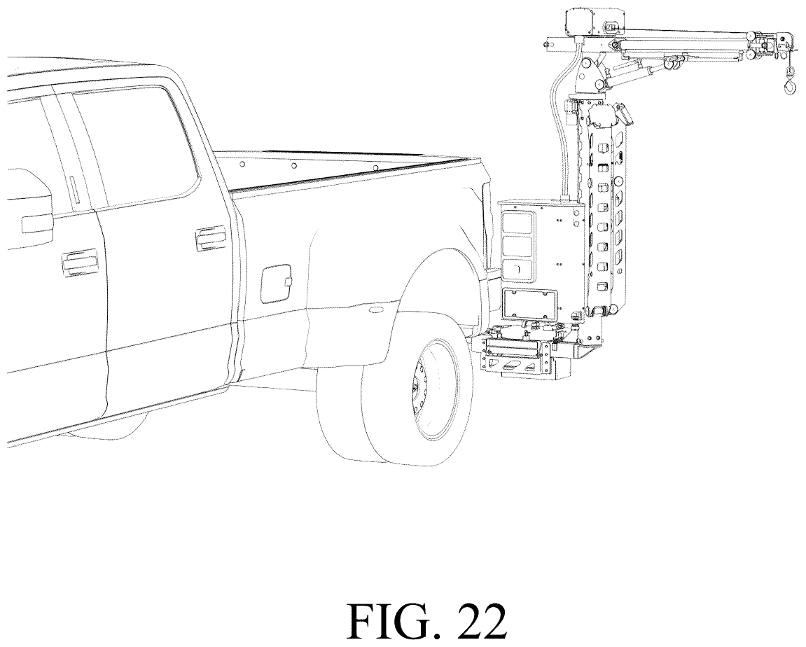

FIG. 22 is a diagram showing a perspective view of an example deployed motorized crane assembly mounted to a vehicle tow hitch in accordance with some implementations.

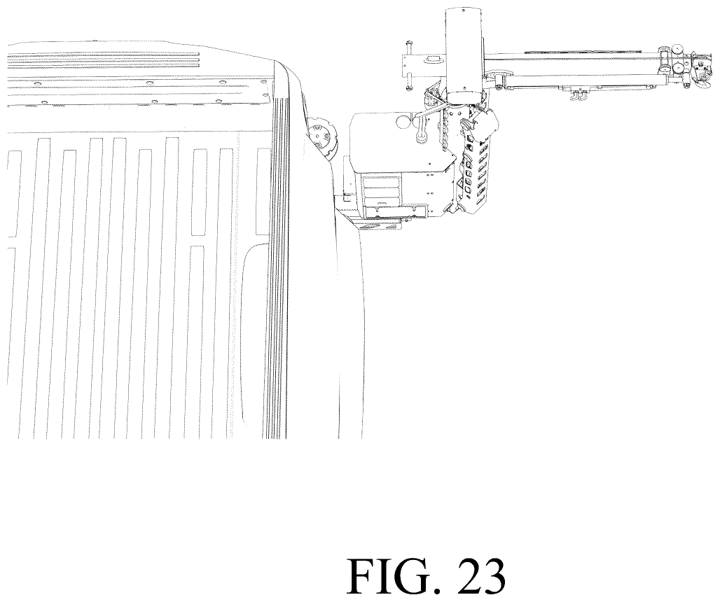

FIG. 23 is a diagram showing a top perspective view of an example deployed motorized crane assembly mounted to a vehicle tow hitch in accordance with some implementations.

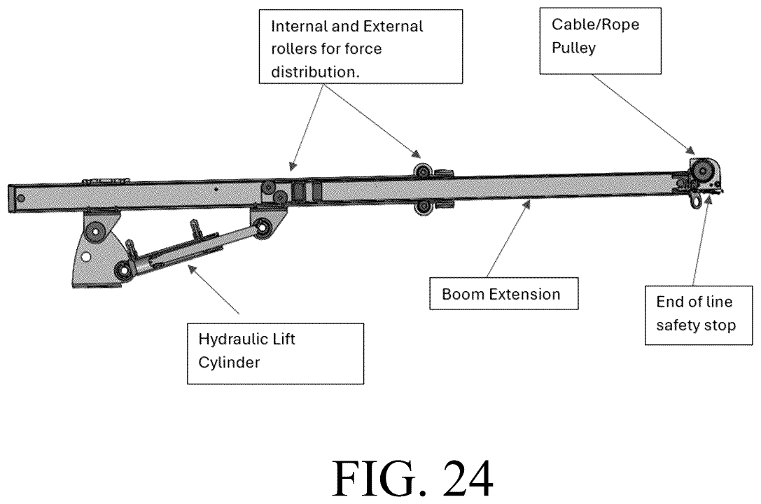

FIG. 24 is a diagram showing a detailed view of an example crane boom in accordance with some implementations.

In some implementations, the boom includes a first set of support rollers and a second set of support rollers, wherein the first set of support rollers support the boom extension on a first axis and the second set of support rollers support the boom extension on a second axis. In some implementations, the hoist is one of an electric hoist or hydraulic hoist. In some implementations, the rope includes one of a synthetic rope or a wire rope.

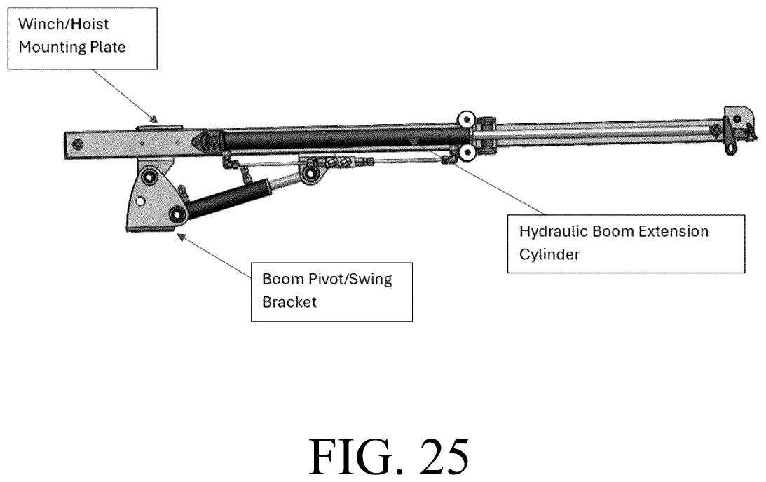

FIG. 25 is a diagram showing a detailed view of an example crane boom in accordance with some implementations.

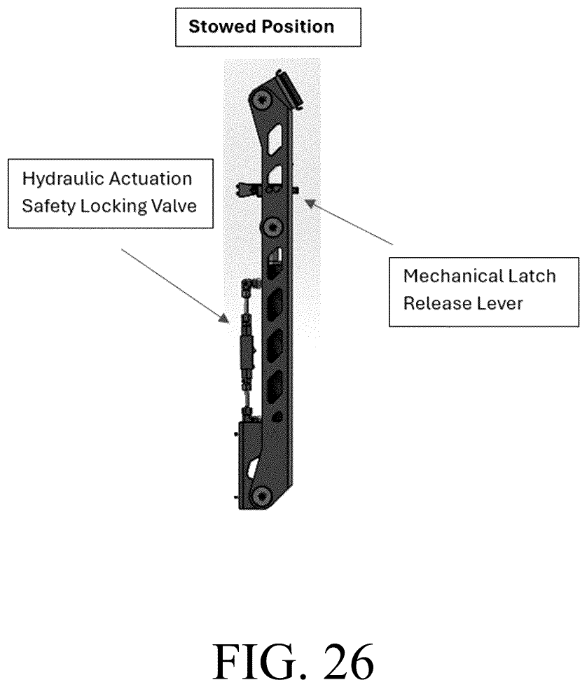

FIG. 26 is a diagram showing a detailed view of an example crane outrigger/stabilizer in a stowed position in accordance with some implementations.

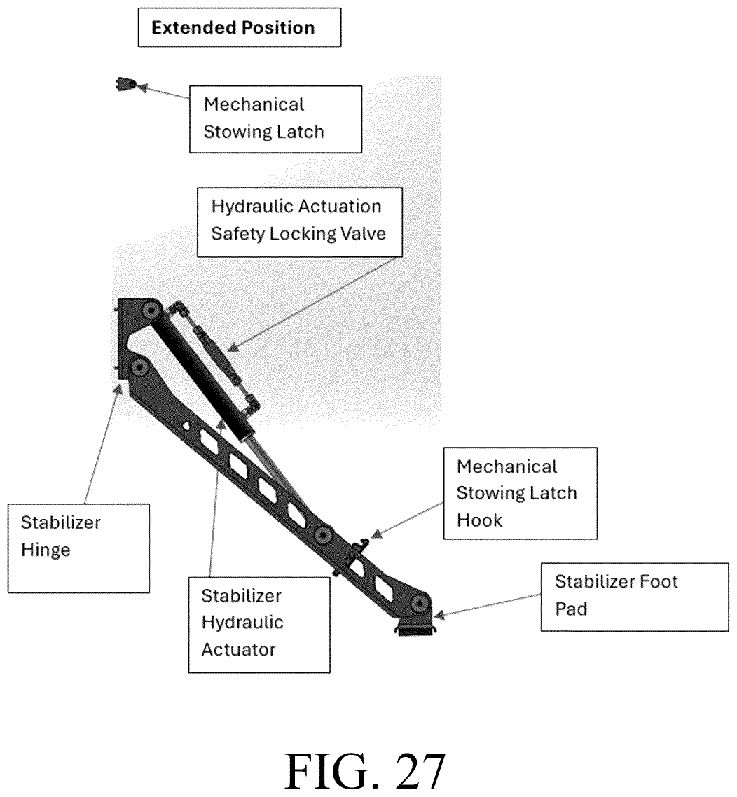

FIG. 27 is a diagram showing a detailed view of an example crane outrigger/stabilizer in a deployed position in accordance with some implementations.

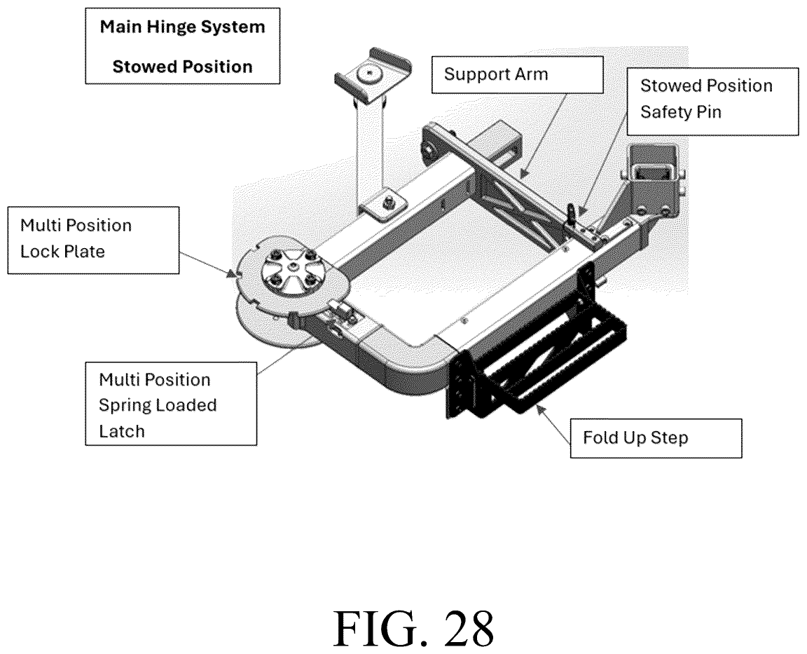

FIG. 28 is a diagram showing a detailed view of an example vehicle tow hitch mount in a stowed position in accordance with some implementations.

In some implementations, the interlocking clevis includes one or more index notches and a spring-loaded slide switch mounted on the base frame member, wherein the spring-loaded slide switch includes a spring-loaded pop-up button for safety. The spring-loaded slide switch is configured to latch the interlocking clevis in a given position corresponding to a given one of the one or more notches into which the spring-loaded slide switch is locked into.

The interlocking clevis has many applications beyond the application shown herein for the crane assembly. The multi-position spring latch includes a spring-loaded pop-up button that, when depressed, permits the spring-loaded latch to move from a first position engaging a slot in the interlocking clevis to a second position not engaging the clot such that it permits the interlocking clevis to rotate. When the spring-loaded latch is released, it returns to a latched position by engaging a slot of the interlocking clevis to lock the interlocking clevis into a given position. The interlocking clevis provides a safety measure in that if the spring loaded latch is not placed into a given slot, if the clevis rotates, as the next slot aligns with the spring loaded latch, the latch will engage the slot under urge of the spring loading and lock the clevis into place and prevent it from freely rotating.

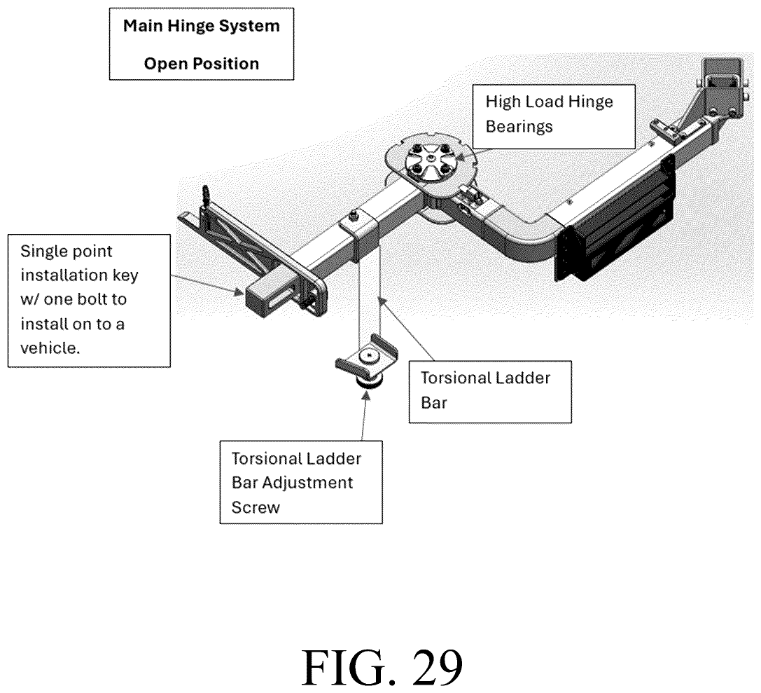

FIG. 29 is a diagram showing a detailed view of an example vehicle tow hitch mount in a deployed position in accordance with some implementations. FIG. 29 shows a reinforcement arm with a tensioner knob that helps resist the torsion moment arm when articulating all that weight, before picking it up on the outrigger/stabilizers.

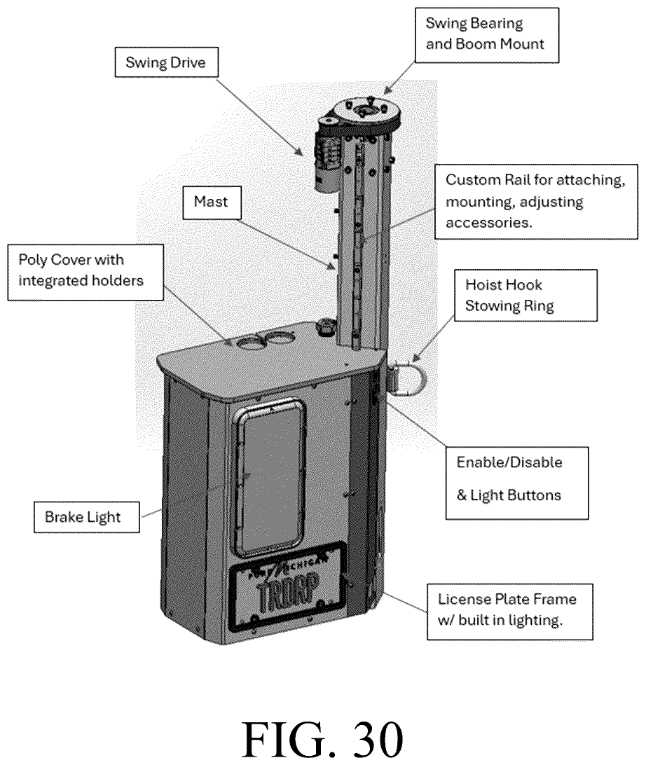

FIG. 30 is a diagram showing a detailed view of an example crane control housing and mast in accordance with some implementations.

FIG. 31 is a diagram showing a detailed view of an example crane hydraulic system schematic in accordance with some implementations.

FIG. 32 is a diagram showing a detailed view of an example crane electrical system schematic in accordance with some implementations.

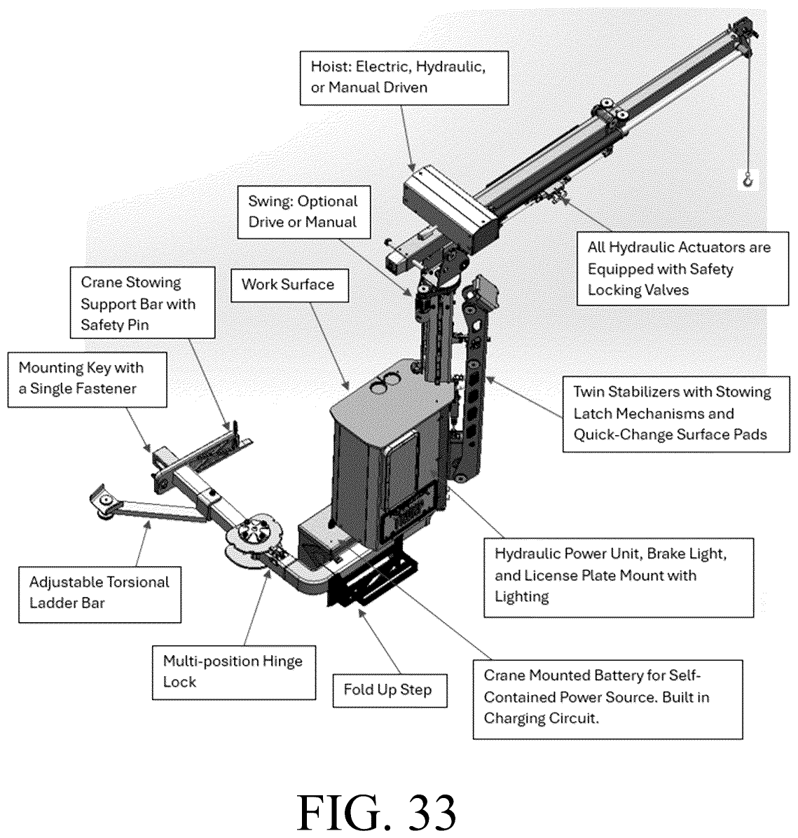

FIG. 33 is a diagram showing a detailed view of example crane features in accordance with some implementations.

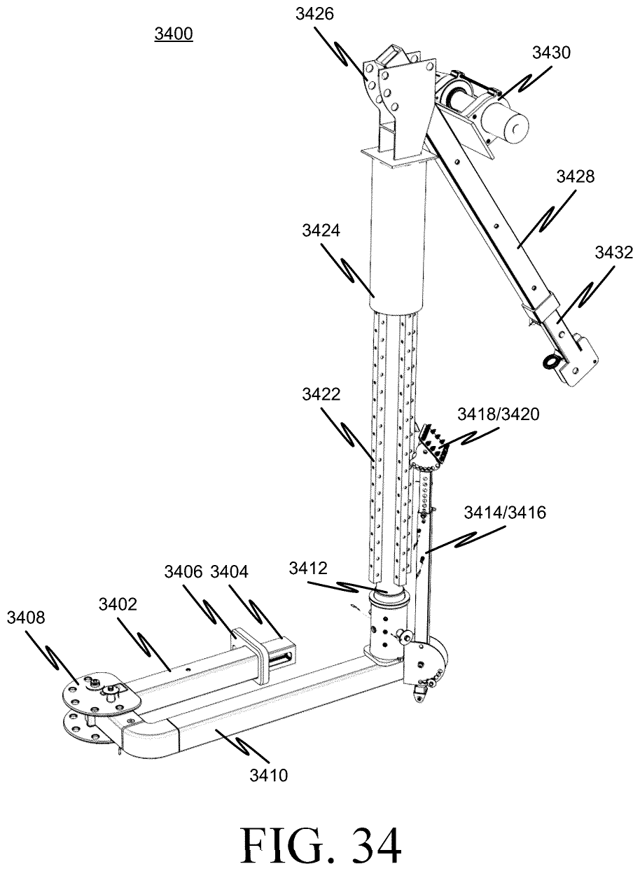

FIG. 34 is a diagram showing a front view of an example manual crane assembly in accordance with some implementations.

Some implementations can include a manual crane assembly 3400 constructed to attach to a vehicle tow hitch. The crane assembly 3400 includes a keyed mounting arm 3402 including a key 3404 and interlocking flange 3406 constructed as a single weldment, a clevis 3408 coupled to the keyed mounting arm 3402, and a base frame member 3410 coupled to the clevis so as to rotate from a stowed crane position to a deployed crane position via the clevis 3410. The clevis 3408 can include a removable locking pin and hole type as shown or can include the clevis of 100 described above. The crane assembly 3400 can also include a mast 3412 coupled to the base frame member 3410 at a first end of the mast, one or more outriggers 3414/3416 mounted to the mast 3412 so as to rotate from a stowed outrigger position to a deployed outrigger position and having a corresponding foot pad 3418/3420, and a boom clevis 3426 mounted to a second end of the mast 3412 configured to rotate the boom 3428 about the second end of the mast 3412. The crane assembly 3400 can attach to the vehicle tow hitch in a manner similar to that described above for crane assembly 100. The winch or hoist of 3400 can include the types of winches or hoists described above.

The crane assembly 3400 can further include a boom 3412 mounted to the boom clevis 3426 so as to rotate relative to the boom clevis 3426, a hoist 3430 coupled to the boom 3428 having a rope wound on a cylinder, where the hoist is configured to release or retract the rope, and a hook coupled to an end of the rope and disposed at a distal end of the boom extension (similar to that shown for 100).

The crane assembly 3400 can also include one or more rails 3422 mounted on the mast 3412. In some implementations, the hoist 3430 is one of an electric hoist or hydraulic hoist. In some implementations, the rope includes one of a synthetic rope or a wire rope. The crane assembly further includes a wired remote control, or a wireless remote control configured to operate the hoist.

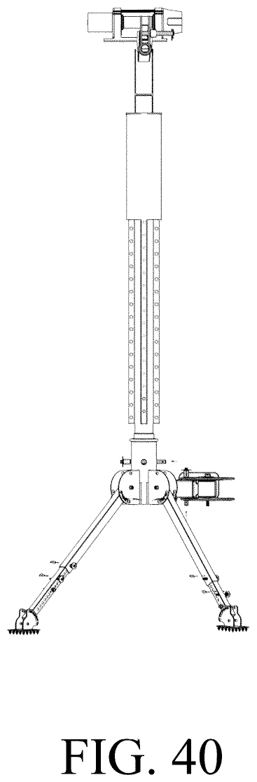

In some implementations, the one or more outriggers 3414/3416 each have a locking rotational hinge configured to lock the outrigger into place (see, e.g., FIG. 40). The crane assembly can also include one or more rails mounted on the boom.

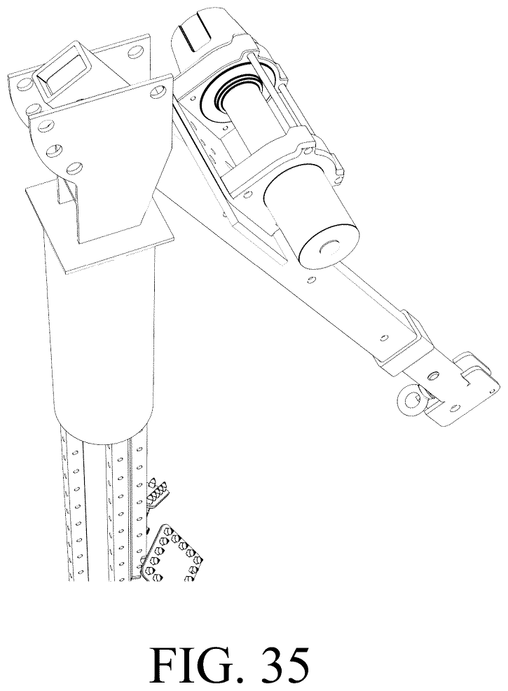

FIG. 35 is a diagram showing a detailed view of an example manual crane assembly mast-boom connection in accordance with some implementations.

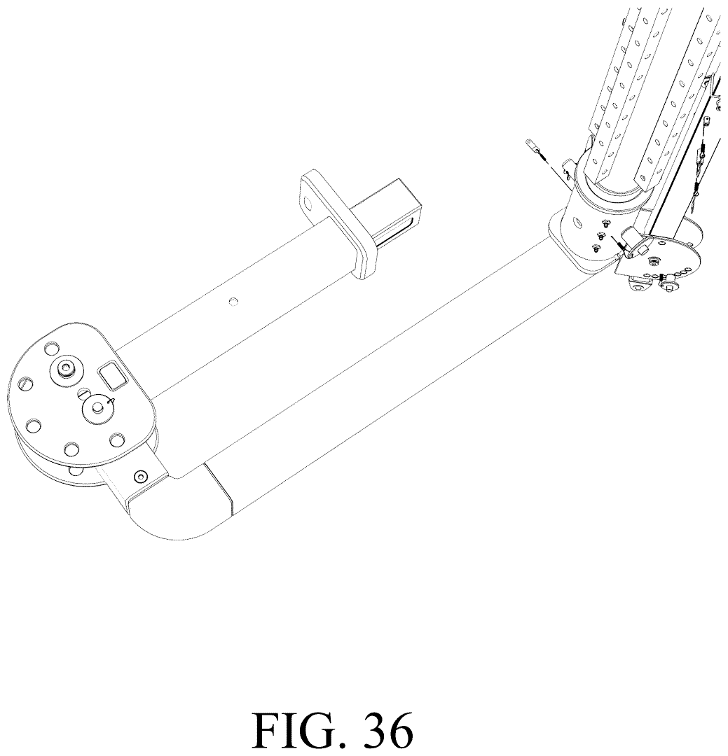

FIG. 36 is a diagram showing a detailed view of an example manual crane assembly vehicle tow hitch mount in accordance with some implementations.

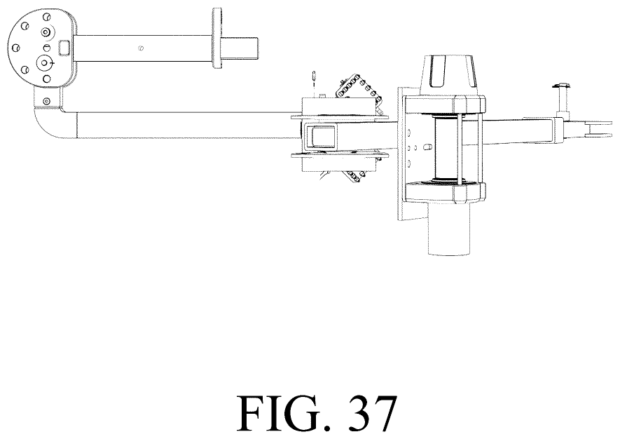

FIG. 37 is a diagram showing a detailed top view of an example manual crane assembly vehicle tow hitch mount in accordance with some implementations.

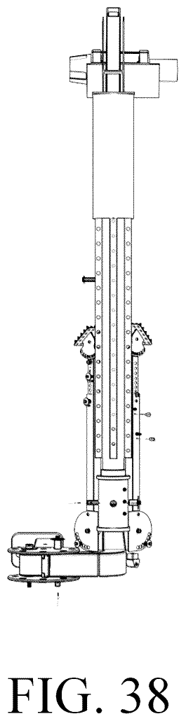

FIG. 38 is a diagram showing a side view of an example manual crane assembly in accordance with some implementations.

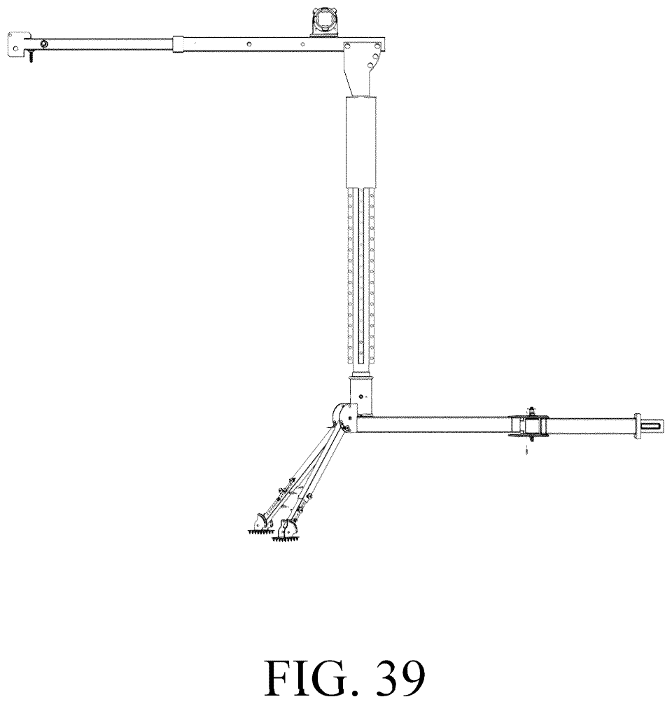

FIG. 39 is a diagram showing a front view of an example deployed manual crane assembly in accordance with some implementations.

FIG. 40 is a diagram showing a side view of an example deployed manual crane assembly in accordance with some implementations.

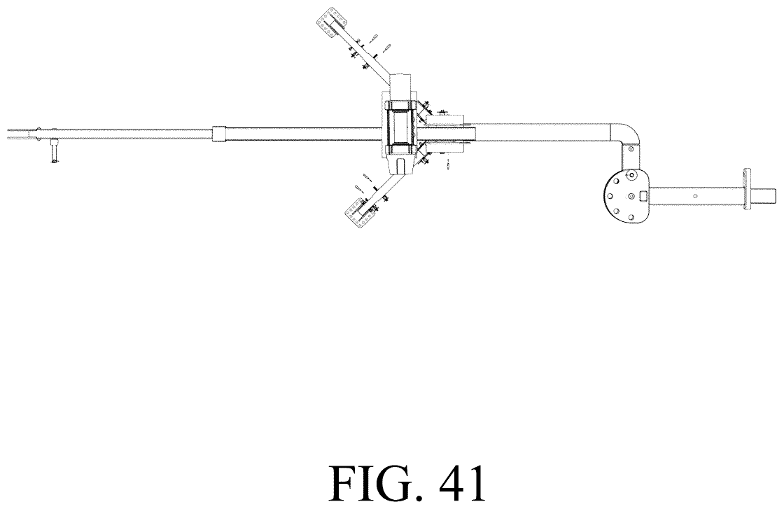

FIG. 41 is a diagram showing a top view of an example deployed manual crane assembly in accordance with some implementations.

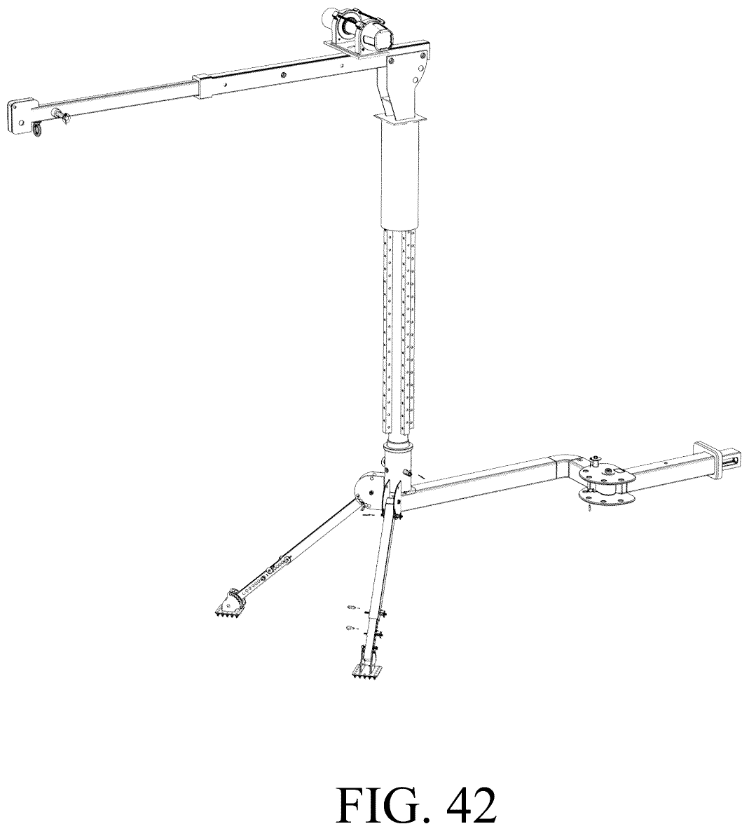

FIG. 42 is a diagram showing a top view of an example deployed manual crane assembly in accordance with some implementations.

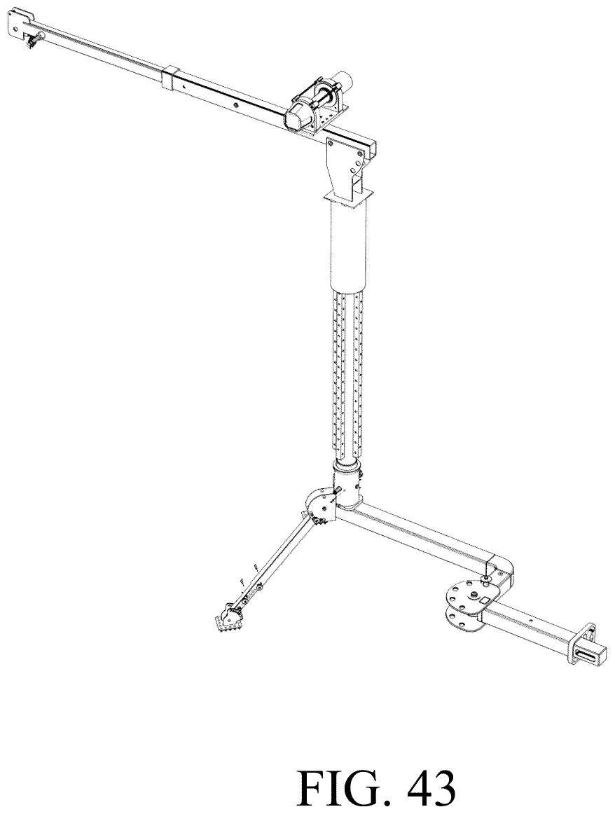

FIG. 43 is a diagram showing a perspective view of an example deployed manual crane assembly in accordance with some implementations.

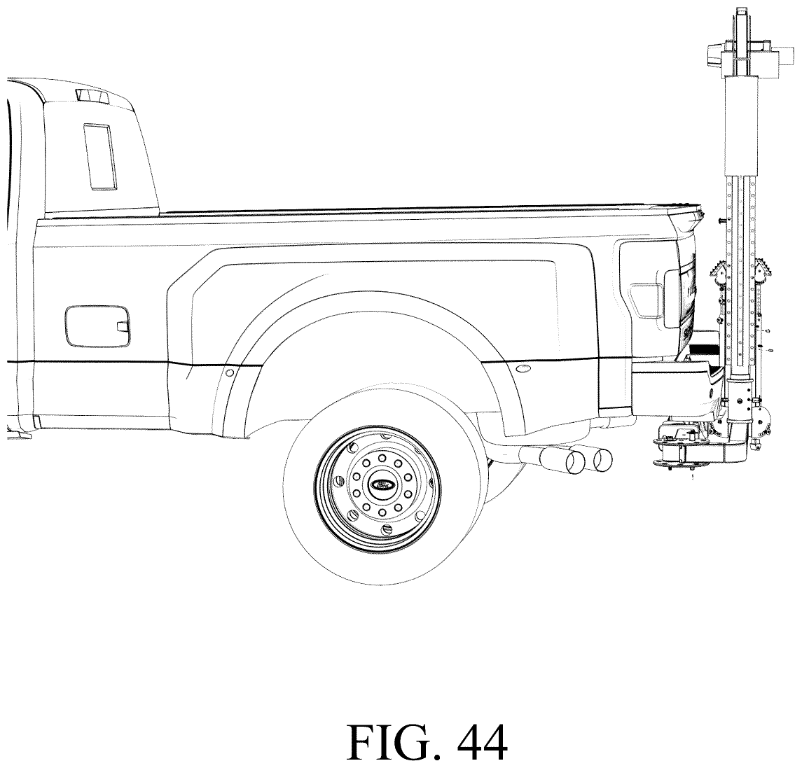

FIG. 44 is a diagram showing an example stowed manual crane assembly mounted on a vehicle in accordance with some implementations.

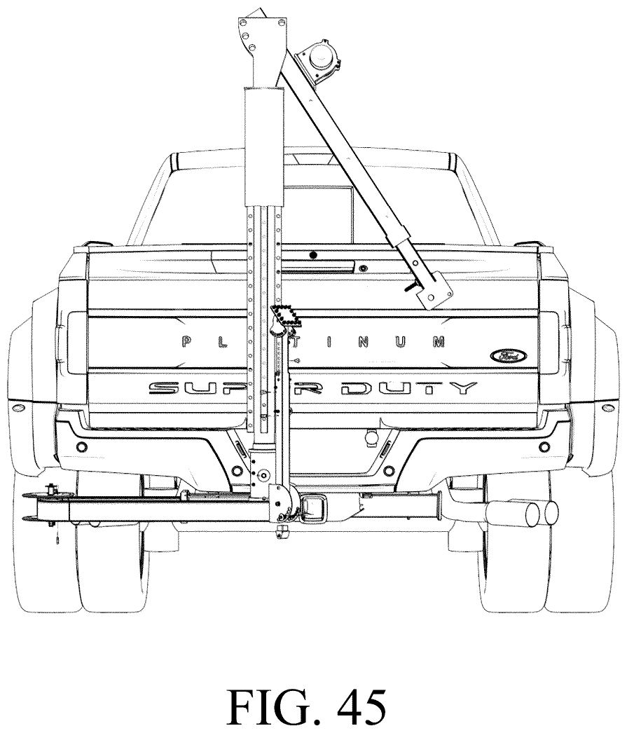

FIG. 45 is a diagram showing an example stowed manual crane assembly mounted on a vehicle in accordance with some implementations.

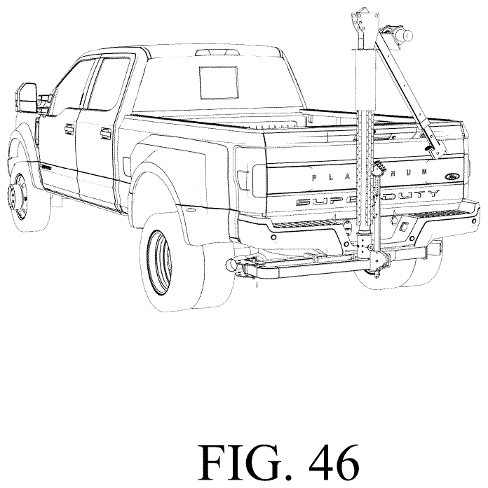

FIG. 46 is a diagram showing an example stowed manual crane assembly mounted on a vehicle in accordance with some implementations.

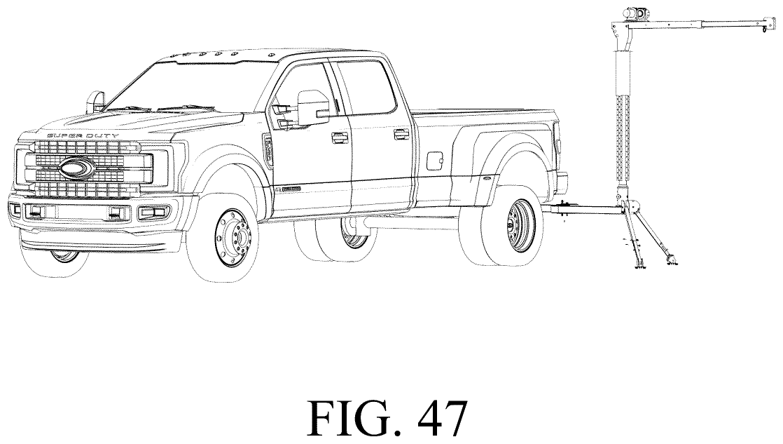

FIG. 47 is a diagram showing an example deployed manual crane assembly mounted on a vehicle in accordance with some implementations.

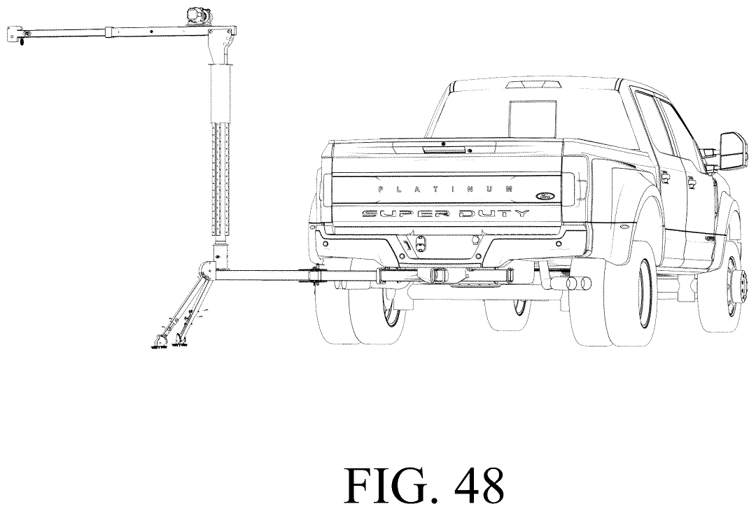

FIG. 48 is a diagram showing an example deployed manual crane assembly mounted on a vehicle in accordance with some implementations.

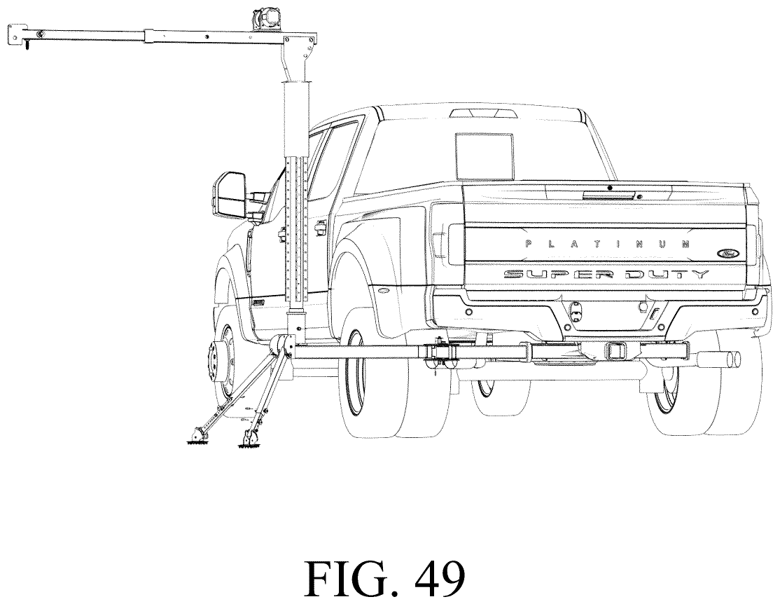

FIG. 49 is a diagram showing an example deployed manual crane assembly mounted on a vehicle in accordance with some implementations.

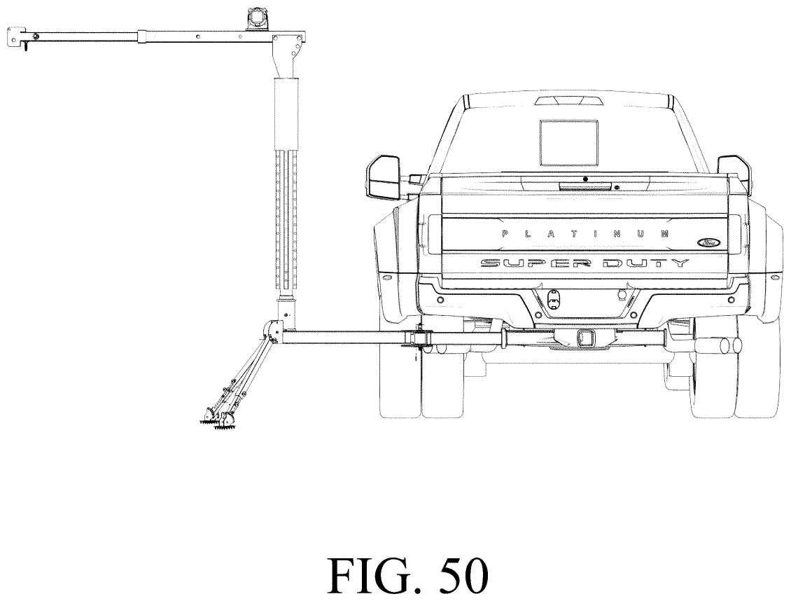

FIG. 50 is a diagram showing an example deployed manual crane assembly mounted on a vehicle in accordance with some implementations.

While some example implementations have been described in terms of a general embodiment with several specific example modifications, it is recognized that other modifications and variations of the embodiments described above are within the spirit and scope of the disclosed subject matter. Applicant intends to embrace any and all such modifications, variations and embodiments.

What is claimed is:

1. A crane assembly constructed to attach to a vehicle tow hitch, the crane assembly comprising:
a keyed mounting arm including a key and interlocking flange constructed as a single weldment;
an interlocking clevis coupled to the keyed mounting arm;
a base frame member coupled to the interlocking clevis so as to rotate from a stowed crane position to a deployed crane position via the interlocking clevis;
a mast coupled to the base frame member at a first end of the mast;
one or more outriggers mounted to the mast so as to rotate from a stowed outrigger position to a deployed outrigger position and having a corresponding foot pad and an outrigger actuator to move the outrigger between the stowed outrigger position and the deployed outrigger position;
a boom clevis mounted to a second end of the mast wherein the boom clevis is coupled to a boom rotation actuator configured to rotate the boom about the second end of the mast;
a boom mounted to the boom clevis so as to rotate relative to the boom clevis;
a boom lift actuator coupled the boom and the boom clevis and configured to move the boom between a first boom angle and a second boom angle;
a boom extension constructed to fit within the boom and to slide along an axis of the boom in response to a boom extension actuator coupled to the boom and the boom extension;
a hoist coupled to the boom having a rope wound on a cylinder, where the hoist is configured to release or retract the rope;
a hook coupled to an end of the rope and disposed at a distal end of the boom extension;
an actuator control system; and
an electrical control system.

2. The crane assembly of claim 1, wherein the interlocking clevis includes one or more index notches and a spring-loaded slide switch mounted on the base frame member, wherein the spring-loaded slide switch includes a spring-loaded pop-up button for safety latching the interlocking clevis in a given position corresponding to a given one of the one or more notches into which the spring-loaded slide switch is locked into.

3. The crane assembly of claim 1, further comprising one or more rails mounted on the mast.

4. The crane assembly of claim 1, wherein the outrigger actuator is a hydraulic actuator.

5. The crane assembly of claim 1, further comprising a mast pivot device configured to rotate the boom clevis about the second end of the mast.

6. The crane assembly of claim 1, wherein the boom includes a first set of support rollers and a second set of support rollers, wherein the first set of support rollers support the boom extension on a first axis and the second set of support rollers support the boom extension on a second axis.

7. The crane assembly of claim 1, wherein the hoist is one of an electric hoist or hydraulic hoist.

8. The crane assembly of claim 1, wherein the rope includes one of a synthetic rope or a wire rope.

9. The crane assembly of claim 1, further comprising a wired remote control or a wireless remote control.

10. The crane assembly of claim 1, wherein the actuator control system is a hydraulic control system having a hydraulic pump and one or more hydraulic valves.

11. The crane assembly of claim 1, wherein the electrical control system includes a plurality of outputs each corresponding to a direction of movement of an actuator.

12. A crane assembly constructed to attach to a vehicle tow hitch, the crane assembly comprising:
a keyed mounting arm including a key and interlocking flange constructed as a single weldment;
a clevis coupled to the keyed mounting arm;
a base frame member coupled to the clevis so as to rotate from a stowed crane position to a deployed crane position via the clevis;
a mast coupled to the base frame member at a first end of the mast;
one or more outriggers mounted to the mast so as to rotate from a stowed outrigger position to a deployed outrigger position and having a corresponding foot pad;
a boom clevis mounted to a second end of the mast configured to rotate the boom about the second end of the mast;
a boom mounted to the boom clevis so as to rotate relative to the boom clevis;
a hoist coupled to the boom having a rope wound on a cylinder, where the hoist is configured to release or retract the rope; and
a hook coupled to an end of the rope and disposed at a distal end of the boom extension.

13. The crane assembly of claim 12, further comprising one or more rails mounted on the mast.

14. The crane assembly of claim 12, wherein the hoist is one of an electric hoist or hydraulic hoist.

15. The crane assembly of claim 12, wherein the rope includes one of a synthetic rope or a wire rope.

16. The crane assembly of claim 12, further comprising a wired remote control or a wireless remote control configured to operate the hoist.

17. The crane assembly of claim 12, wherein the one or more outriggers each have a locking rotational hinge configured to lock the outrigger into place.

18. The crane assembly of claim 12, further comprising one or more rails mounted on the boom.
